(19) United States
(12) Patent Application Publication
(10) Pub. No.: US 2009/0147155 A1
(43) Pub. Date: Jun. 11, 2009

(54) DIGITAL PHOTO FRAME

(75) Inventors: SHIH-LUNG HSU, Tu-Cheng (TW); LUNG DAI, Tu-Cheng (TW); YUAN-BOR JEAN, Tu-Cheng (TW)

Correspondence Address: PCE INDUSTRY, INC.;ATT. Steven Reiss, 458 E. LAMBERT ROAD, FULLERTON, CA, 92835, US

(73) Assignee: HON HAI PRECISION INDUSTRY CO., LTD., Tu-Cheng (TW)

(21) Appl. No.: 12/124,170

(22) Filed: May 21, 2008

(30) Foreign Application Priority Data
Dec. 7, 2007 (CN) 200710202920.1

(51) Int. Cl. H04N 5/64; G06F 1/16; A47G 1/06

(52) U.S. Cl. 348/836; 348/E05.128

(57) ABSTRACT

A digital photo frame includes a transparent front frame, a back frame detachably coupled to the front frame, and a display screen accommodated between the front frame and the back frame for displaying digital photos. The digital photos can be seen through from the transparent front frame.

### BACKGROUND

1. Field of the Invention

The present invention generally relates to display devices, and particularly to a digital photo frame for displaying digital photos.

2. Description of related art

It is known that digital photo frames are replacing conventional photo frames or photo albums. A digital photo frame generally includes a frame member and a liquid crystal display (LCD) screen accommodated in the frame member. Digital photo frames are popular because digital photos can be displayed by the LCD screen of the digital photo frames without developing or printing the digital photos.

However, the frame member is typically made of plastic, wood, or the like with fixed color and texture. When different style digital photos such as natural landscape photos, human photos, animal photos, and so on are displayed, the frame member cannot change its appearance in cooperation with the different photo styles for obtaining better display effects. Thus, current digital photo frames have limited display characteristics in displaying digital photos having different styles.

Therefore, a digital photo frame with improved display characteristics in displaying different style digital photos is desired.

### SUMMARY

Accordingly, a digital photo frame with improved display characteristics in displaying different style digital photos is provided. The digital photo frame includes a transparent front frame, a back frame detachably coupled to the transparent front frame, and a display screen accommodated between the transparent front frame and the back frame for displaying digital photos. The digital photos can be seen through from the transparent front frame.

Other advantages and novel features will become more apparent from the following detailed description of exemplary embodiment when taken in conjunction with the accompanying drawings.

### BRIEF DESCRIPTION OF THE DRAWINGS

FIG. 1 is an isometric view of a digital photo frame in accordance with an exemplary embodiment.

FIG. 2 is an exploded view of the digital photo frame shown in FIG. 1.

### DETAILED DESCRIPTION

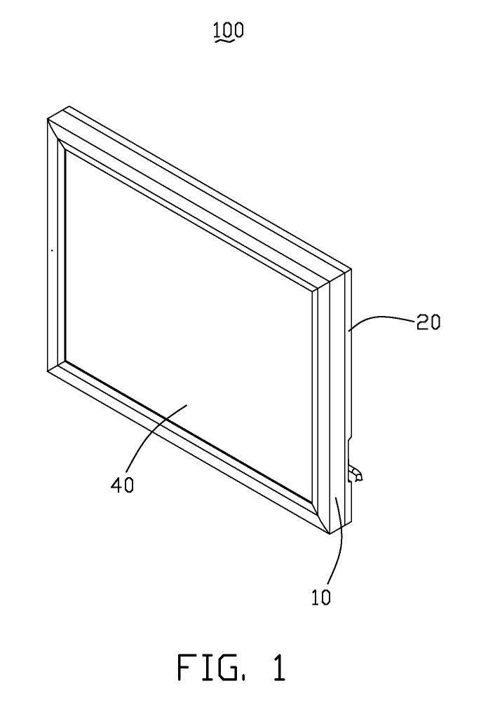

Referring to FIG. 1, a digital photo frame 100 in accordance with an exemplary embodiment is illustrated. The digital photo frame 100 generally includes a front frame 10, a back frame 20, and a display screen 40. The front frame 10 and the back frame 20 are detachably engaged with each other, and are sized to accommodate the display screen 40. The front frame 10 is made of transparent material such as polycarbonate and polymethyl methacrylate. Digital photos displayed on the display screen 40 can also be seen through from the front frame 10.

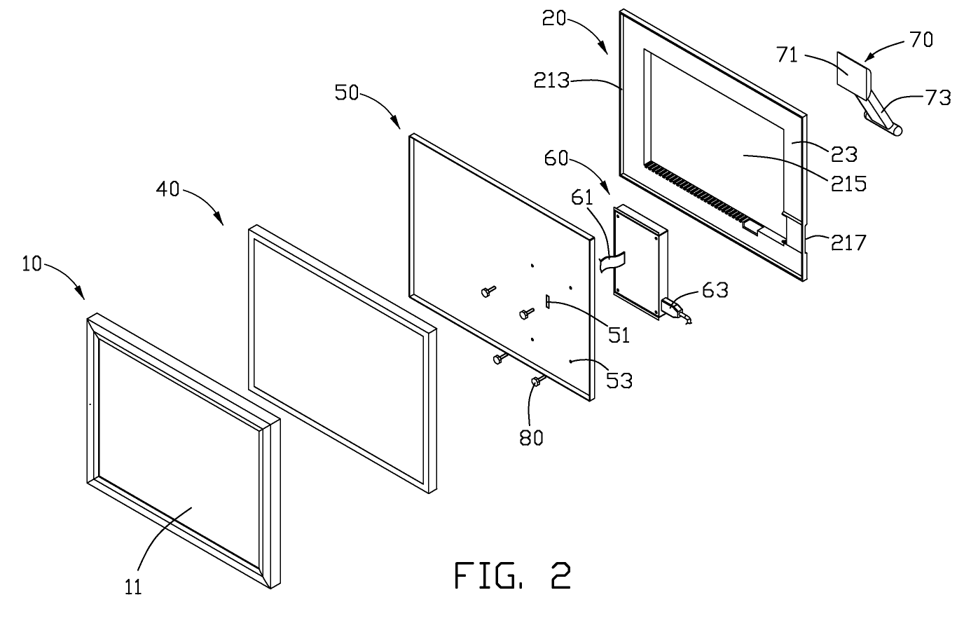

Referring to FIG. 2, the digital photo frame 100 further includes a spacing plate 50, a circuit module 60, and a support member 70.

The front frame 10 defines a rectangular view window 11 with a size generally corresponding to a display area of the display screen 40.

The spacing plate 50 is rectangular with a size conforming to the display screen 40. The spacing plate 50 defines a slit 51 and a plurality of positioning holes 53. The slit 51 is defined in an area surrounded by the plurality of positioning holes 53. The slit 51 is configured for a flexible printed circuit (FPC) 61 of the circuit module 60 to pass through. The FPC 61 is electrically connected to the display screen 40. The plurality of positioning holes 53 are configured for the plurality of screws 80 to pass through. The circuit module 60 is fastened to the spacing plate 50 by fastening the screws 80 through the plurality of positioning holes 53 into a plurality of screw holes 65 defined in the circuit module 60 correspondingly.

In addition, the spacing plate 50 is configured for reducing electromagnetic radiation (EMR) and electromagnetic interference (EMI).

The circuit module 60 is configured for storing image files and transmitting data of the image files to the display screen 40. The circuit module 60 is further capable of being coupled with an external device such as a personal computer (not shown) via a connector cable 63, for transferring the image files from the personal computer to the circuit module 60 and vice versa.

The back frame 20 includes a back plate 23 The back plate 23 forms a flange 213 extending from out periphery of the back plate 23. The flange 213 is engageably coupled with the front frame 10. The back plate 23 defines a substantially rectangular recess 215 for receiving at least the circuit module 60.

The back plate 23 also defines a cable channel 217 corresponding to the connector cable 63 of the circuit module 60. The cable channel 217 communicates between a peripheral edge of the back plate 21 and the recess 215. The cable channel 217 is configured to allow the connector cable 63 to extend through, such that wires within the cable do not become fatigue adjacent to the back plate 23.

The support member 70 includes a base 71 and a support bracket 73. The base 71 is attached to the back plate 23. The support bracket 73 is pivotably connected to the base 71, and generally disposed on a horizontal surface (not shown) such as a table, a desk, etc. The support bracket 73 may be pivoted relative to the base 71 to adjust an optimized angle of the display screen 40 with respect to the horizontal surface according to preference.

In assembling the digital photo frame 100, the circuit module 60 is fastened to the spacing plate 50, the FPC 61 of the circuit module 60 passes through the slit 51 and electrically connected to the display screen 40. The circuit module 60 is also received in the recess 215 of the back frame 20 with the connector cable 63 extending through the cable channel 217. The display screen 40, the spacing plate 50 fastened with the circuit module 60 are sequentially arranged between the front frame 10 and the back frame 20, thus constructing the digital photo frame 100.

In use, the digital photo frame 100 may stand on a table and be supported by the support member 70. When the digital photo frame 100 is powered up, digital images from the image files stored in the circuit module 60 are displayed on the display screen 40, and are viewable via the view window 11. Because the front frame 10 is transparent, edges of the digital image will be seen through the front frame 10. As a result, the front frame 10 would seem to adopt different physical characteristics (color, intensity, etc) according to the digital images displayed. Therefore, a display characteristic of the digital photo frame 100 is improved.

It will be understood that spatially relative terms, such as “front”, “back” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “front” will seem to be oriented as “back” to other elements or features. Thus, the example term “front” can encompass both an orientation of front and back. The device may be otherwise oriented (rotated 90 degrees or at other orientations) and the spatially relative descriptors used herein interpreted accordingly.

The foregoing description of the exemplary embodiments of the invention has been presented only for the purposes of illustration and description and is not intended to be exhaustive or to limit the invention to the precise forms disclosed. Many modifications and variations are possible in light of the above teaching. The embodiments were chosen and described in order to explain the principles of the invention and their practical application so as to enable others skilled in the art to utilize the invention and various embodiments and with various modifications as are suited to the particular use contemplated. Alternative embodiments will become apparent to those skilled in the art to which the present invention pertains without departing from its spirit and scope. Accordingly, the scope of the present invention is defined by the appended claims rather than the foregoing description and the exemplary embodiments described therein.

What is claimed is:

1. A digital photo frame, comprising:
a transparent front frame;
a back frame detachably coupled to the front frame; and
a display screen accommodated between the front frame and the back frame for displaying digital photos thereon, the digital photos being seen through from the transparent front frame.

2. The digital photo frame of claim 1, wherein the front frame defines a view window for presenting the displayed digital photos.

3. The digital photo frame of claim 1, wherein the back frame comprises a back plate, the back plate forms a flange extending along out periphery of the back plate.

4. The digital photo frame of claim 3, wherein the back plate forms a substantially rectangular recess.

5. The digital photo frame of claim 4, wherein the back plate defines a cable channel communicating between the out periphery of the back plate and the recess.

6. The digital photo frame of claim 1, further comprising a support member pivotably attached to the back frame.

7. The digital photo frame of claim 6, wherein the support member comprises a base and a support bracket, the base is attached to the back frame, the support bracket is pivotably connected to the base.

8. The digital photo frame of claim 1, further comprising a spacing plate arranged between the display screen and the back frame.

9. The digital photo frame of claim 8, wherein the spacing plate is configured for reducing electromagnetic radiation and electromagnetic interference.

10. The digital photo frame of claim 8, wherein the spacing plate defines a plurality of positioning holes and a slit.

11. The digital photo frame of claim 10, further comprising a circuit module, the circuit module is screwed to the spacing plate by a plurality of screws extending through the corresponding positioning holes.

12. The digital photo frame of claim 10, wherein the circuit module has a flexible printed circuit, the flexible printed circuit passes through the slit and electrically connects to the display screen.

13. A digital photo frame, comprising:
a first frame made of transparent material;
a second frame secured to the first frame;
a display screen accommodated between the first frame and the second frame for displaying digital photos thereon;
a circuit module arranged between the display screen and the second frame for providing digital photos to the display screen, the digital photos being seen through from the first frame; and
a support member pivotably attached to the second frame for supporting the second frame on a horizontal surface and adjusting an angle of the display screen with respect to the horizontal surface.

14. The digital photo frame of claim 13, wherein the support member comprises a base and a support bracket, the base is attached to the second frame, the support bracket is pivotably attached to the base.

15. The digital photo frame of claim 13, further comprising a spacing plate disposed between the display screen and the second frame.

16. The digital photo frame of claim 15, wherein the spacing plate defines a slit for a flexible printed circuit to pass therethrough, the flexible printed circuit is electrically connected to the display screen.

17. The digital photo frame of claim 16, wherein the slit is surrounded by the plurality of positioning holes.

18. The digital photo frame of claim 15, wherein the spacing plate is configured for reducing electromagnetic radiation and electromagnetic interference.

19. The digital photo frame of claim 13, wherein the first frame is made of polycarbonate or polymethyl methacrylate.

20. The digital photo frame of claim 13, wherein the second frame defines a substantially rectangular recess for receiving the circuit module.
